(19) United States
(12) Patent Application Publication
(10) Pub. No.: US 2019/0171171 A1
(43) Pub. Date: Jun. 6, 2019

(54) ZONE-BASED BUILDING CONTROL AND MONITORING SYSTEM

(71) Applicant: Spaceti LG Ltd., London (GB)

(72) Inventors: Maksym Verteletskyi, Prague (CZ); Maksym Huk, Prague (CZ); Aakash Ravi, Stamford, CT (US); Ondrej Plevka, Prague (CZ); Tomás Barták, Chrudim (CZ); Dan Suster, Ceske Budejovice (CZ); Mario Kamburov, Prague (CZ); Petr Stetina, Strancice (CZ)

(21) Appl. No.: 16/211,091

(22) Filed: Dec. 5, 2018

(30) Foreign Application Priority Data
Dec. 6, 2017 (GB) 1720331.6

(51) Int. Cl. G05B 19/042

(52) U.S. Cl. CPC G05B 19/042; G05B 2219/2614; G05B 2219/25011

(57) ABSTRACT

Systems and methods for controlling environmental conditions in a building are described herein. The system determines real-time locations of one or more user devices. When an occupant of the building uses a user device to send a request to change an environmental condition, the system identifies a control zone that corresponds to a current location of the user device and determines a system setting for the subsystem that is associated with the requested change. The determined system setting is communicated to the subsystem to implement the change in the environmental condition at the control zone in response to the requested change.

### CROSS-REFERENCE TO RELATED APPLICATION(S)

This application claims the benefit of and priority to U. K. Patent Application No. 1720331.6, titled “SYSTEMS INTEGRATOR, BUILDING MANAGEMENT, CONTROL AND MONITORING SYSTEM” and filed Dec. 6, 2017, which is incorporated herein by reference in its entirety.

This application contains subject matter related to a concurrently-filed PCT Patent Application by Maksym Verteletskyi, Maksym Huk, Aakash Ravi, Ondřej Plevka, Tornáš Barták, Dan Šuster, and Mario Kamburov, and Petr Štětina titled “BUILDING-RESOURCE MANAGEMENT SYSTEM,” which is assigned to Spaceti LG Ltd., is identified by attorney docket number 129532-8002.W000, and which is incorporated herein by reference in its entirety.

This application contains subject matter related to a concurrently-filed PCT Patent Application by Maksym Verteletskyi, Maksym Huk, Aakash Ravi, Ondřej Plevka, Tornáš Barták, Dan Šuster, and Mario Kamburov, and Petr Štětina titled “ZONE-BASED BUILDING CONTROL AND MONITORING SYSTEM,” which is assigned to Spaceti LG Ltd., is identified by attorney docket number 129532-8001.W000, and which is incorporated herein by reference in its entirety.

### TECHNICAL FIELD

The present invention relates to systems for monitoring and controlling various aspects of buildings, and in particular but not exclusively, a building control and monitoring system for monitoring and controlling a building environment.

### BACKGROUND

In modern settings, buildings include several unconnected and/or stand-alone systems which control different aspects of the building. For example, most buildings have one or more elevators that are operationally controlled by elevator control systems and environmentally controlled by heating-ventilation and air-conditioning (HVAC) systems. Also, some buildings may have energy management systems that control electricity and gas usage, emergency systems that provide back-up power or facilitate emergency scenarios, security systems for monitoring and/or controlling access to different parts of the building, etc. Some large buildings, such as larger office buildings or public use buildings, tend to be fitted with computer-aided facility management (CAFM) systems or building management systems.

However, these various task-based systems traditionally focus on individual tasks without interacting with other systems. For example, the elevator systems typically operate to achieve their preprogrammed goals without regard to the needs or targets of other systems, such as the energy management systems and/or the security systems. Further, many systems typically include devices that are integral or built-in to the building, which can make it difficult to update system capabilities.

While some building management systems (BMSs) seek to solve these problem, not all pre-existing systems are able to provide the data and/or levels of control necessary to implement the BMS. Moreover, the BMSs typically require user input or programming updates to account for system layouts (e.g., an HVAC configuration), building layouts (e.g., a floor plan), etc. As such, each change in the various systems and/or the layouts may require a system update and/or a software update. Moreover, BMSs typically do not interact with building occupants, and thus cannot directly respond to the occupant needs or requests. It would therefore be beneficial to provide a simplified interface between environmental control subsystems and dynamically adjust the various parameters or settings of the subsystem(s) to meet the real-time needs and demands of the building occupants.

### BRIEF DESCRIPTION OF THE DRAWINGS

FIG. 1 is a schematic diagram of an example environment in which a building control and monitoring system may operate according to some embodiments.

FIG. 2 is a block diagram of a building control and monitoring system configured in accordance with some embodiments.

FIG. 3A is a block diagram of a linking device configured in accordance with some embodiments, and FIG. 3B is a flow diagram illustrating an example process for operating the linking device of FIG. 3A according to some embodiments.

FIG. 4 illustrates an example display of a user device configured in accordance with some embodiments.

FIG. 5 is a flow diagram illustrating an example process for implementing a building control and monitoring system according to some embodiments.

FIG. 6 is a block diagram of an example computing device in accordance with various embodiments.

### DETAILED DESCRIPTION

Systems and methods for providing zone-based monitoring and control of buildings are described herein. A zone-based building control and monitoring system configured in accordance with some embodiments allows full or semi-automatic/autonomous control of multiple occupant-related aspects of a building, such as internal environmental conditions, resource scheduling, resource billing, emergency protocols, etc.

The building control and monitoring system can include a control module (e.g., a circuit, such as a processor and a memory including a set of instructions) configured to interface with one or more subsystems of the building, a set of sensors in the building, personal or mobile devices belonging to and/or carried by building occupants, and/or other internal or external systems. The control module can gather various information from the interfacing systems or devices, and according to the gathered information, control one or more of the devices or subsystems associated with the building. The control module can interact with the individual occupants through their mobile devices (e.g., smart phones, wearable devices, etc.) in gathering information and controlling the devices or subsystems of the building. In some embodiments, the control module can track and manage usage of building resources, changes to resource settings, and/or scheduling of the building resources for individual occupants of the building.

In some embodiments, the building control and monitoring system can include a linking device configured to connect the system with environmental conditions (e.g., via onboard sensors), occupant devices, and/or existing subsystems in a building. For example, the linking device can include, be integral with, and/or be connected to wired or wireless access nodes (e.g., wireless routers, network connectors, etc.) that communicate with the occupant devices (e.g., smart phones, wearable devices, access keys, etc.). The linking device can facilitate communication of building-related information between the occupant devices and the control module. Also, the linking device can include circuitry, connections, instructions, etc. configured to interact with a designated building subsystem (e.g., elevator systems, HVAC systems, access/security systems, lighting systems, etc.) including pre-existing and/or older systems that were initially configured to operate as a standalone system/device. Accordingly, the linking device provides the building control and monitoring system increased flexibility in retrofitting buildings having existing standalone systems. Traditional BMSs and CAFM systems often require direct connection to all managed systems, and as such, installation of such systems can require extensive reconstruction/rewiring for the entire building. In contrast, by using a linking device for each subsystem and connecting the linking devices to the control module through a network connection, retrofitting activities and building upgrades can be modularized to allow flexibility in scaling and controlling building construction activities.

In some embodiments, the building control and monitoring system can be configured to autonomously map portions (e.g., floors, occupant units, etc.) in the building. For example, the building control and monitoring system can use a machine-learning mechanism, artificial intelligence, etc. to analyze sensor outputs in response to a change in one or more environmental settings (e.g., lights settings, HVAC status, occupant motions, etc.). Based on the analysis the building control and monitoring system can generate one or more maps of the building that identify zones/spaces that are affected by each controllable component (e.g., air conditioning vent, fan, light, etc.). Accordingly, the building control and monitoring system can autonomously detect tenant-made changes to spaces (e.g., reconfiguration of offices and/or cubicles) in the building and/or account for such changes in controlling the environmental conditions, thus reducing manual calibration/mapping efforts. Further, based on the identified zones, the building control and monitoring system can provide more granular or individualized environmental controls for each occupant.

### Suitable Environments

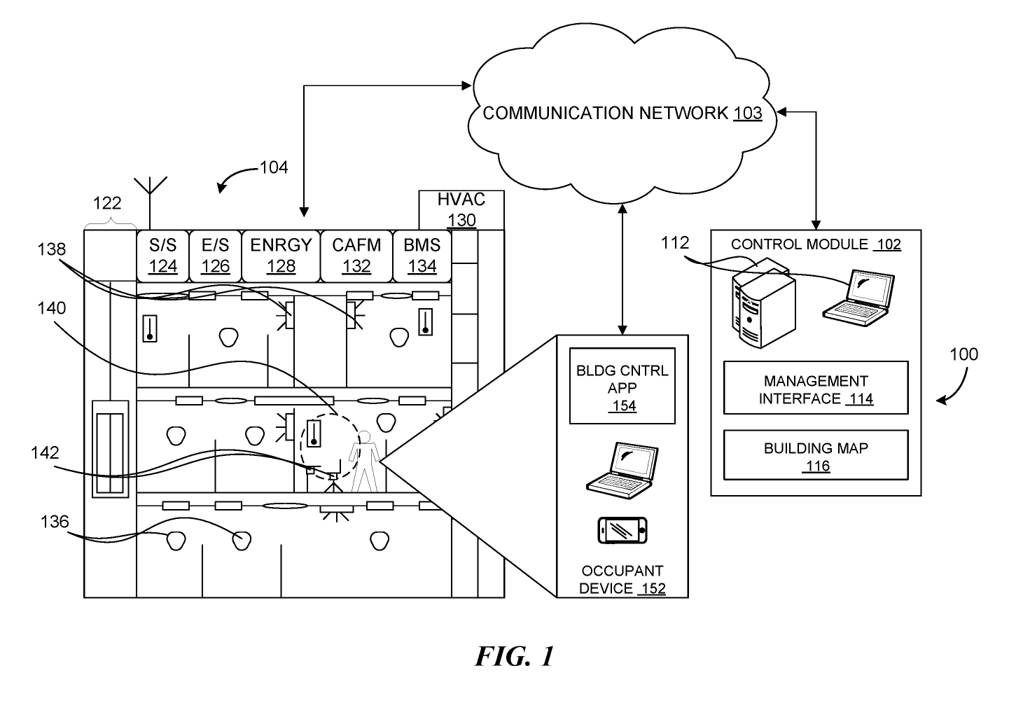

FIG. 1 and the following discussion provide a brief, general description of an example suitable environment in which a building control and monitoring system 100 may be implemented. Although not required, aspects of the invention are described in the general context of computer-executable instructions, such as routines executed by a general-purpose computer, a personal computer, a server, and/or other computing system. The invention can also be embodied in a special purpose computer or data processor that is specifically programmed, configured, and/or constructed to perform one or more of the computer-executable instructions described in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programming logic devices (PLDs), or the like, or a combination of such devices. Computer-executable instructions may be stored in memory, such as random-access memory (RAM), read-only memory (ROM), flash memory, or the like, or a combination of such components. Computer-executable instructions may also be stored in one or more storage devices such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Aspects of the invention can also be practiced in distributed computing environments (e.g., public, private, or hybrid clouds), where tasks or modules are performed by remote processing devices linked through a communications network including, but not limited to, a Local Area Network (LAN), Wide Area Network (WAN), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, or stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer while corresponding portions reside on a client computer.

Referring to the embodiment of FIG. 1, the building control and monitoring system 100 in which aspects of the described technology may operate includes a control module 102 operably configured to interact with and/or manage one or more devices/systems in a building 104. The control module 102 can include circuitry (e.g., a processor connected to a memory including instructions) configured to track and control various aspects/conditions of the building 104 and interact with individual occupants, all in real-time or near real-time. The control module 102 can be implemented using one or more system managing devices 112, such as a server, a general-purpose or specialized computer, or other computing device. The control module 102 can also include a system management interface 114 (e.g., a building management application, a graphic user interface (GUI), and/or other user interfacing mechanism) configured to allow building owners or administrative users to access and interact with the building management system. For example, the system management interface 114 can enable the building owners via the control module 102 (e.g., the system managing devices 112) to access and/or adjust targeted ambient settings (e.g., of the HVAC system, the lighting system, etc.), adjust desired resource consumption or usage rate (e.g., via electrical panel), determine one or more costs associated with occupancy or usage of building resources, view current settings or status of systems/devices, etc. Also, facility users can receive, even at remote locations, real-time status of one or more devices/systems in the building, such as for troubleshooting or repair purposes. Further, managing users or owners can view or track costs, payments, etc. for billing or analytic purposes.

In some embodiments, the control module 102 can include or access one or more maps (e.g., a building map 116) of the building 104. The building map 116 can describe spaces within the building 104, and/or physical characteristics associated with the spaces. For example, the building map 116 can include estimated locations of barriers (e.g., walls, doors, dividers columns, etc.), such as for rooms, offices, and/or cubicles. The building map 116 can also include zones or spaces that are affected by one or more environmental control components (e.g., a fan, a vent, a light fixture, etc.) in the building 104. The building map 116 can further include one or more graphs of routes inside the building 104, locations of emergency exits, exit routes, or a combination thereof. In some embodiments, the control module 102 can be configured to autonomously generate and/or update the building map 116. Details regarding the generation/update of the building map 116 are described below.

The control module 102 can be connected to one or more devices/systems in the building 104, such as to an elevator system 122, a security system 124 (e.g., an access/gate control system, a closed-circuit television (CCTV) system, etc.), an emergency system 126, an energy management system 128, an HVAC system 130, and/or other purpose-specific device/system. In some embodiments, the control module 102 can be connected to one or more smart or comprehensive systems, such as a computer-aided facility management (CAFM) system 132 that allows users (e.g., staff users) to manage spaces within the building 104, a BMS 134, etc. While some BMSs may be configured to sense (e.g., via a network of sensors) and control environmental conditions in the building 104, the operations can be enhanced by the control module 102 via zone-specific monitoring and control of one or more conditions in the building. Further, the control module 102 can be configured to provide additional features not included in the BMS 134, such as: smart/autonomous mapping and associated control adjustments, interacting with and providing controls to individual occupants, providing turn-by-turn indoor navigation for individual occupants, scheduling and managing building resources (e.g., rooms, devices, etc.), etc.

In some embodiments, the control module 102 (e.g., implemented using one or more of the system managing devices 112) can be located at or near the building 104, at a remote location away from the building, and/or in a distributed computing environment. Further, in some embodiments, the control module 102 (e.g. one or more of the system managing devices 112) can be integral with the BMS 134, such as via separate software applications running on the same device or by including the BMS 134 as a component connected to the control module 102.

In some embodiments, the building control and monitoring system 100 can include or utilize a plurality of linking devices 136. The linking devices 136 include circuits configured to facilitate data collection, interface with the building occupants, and/or interface with the devices/subsystems of the building. For example, as described in greater detail below, the linking devices 136 can include environmental and/or status sensors, such as: a temperature sensor, a humidity sensor, a carbon monoxide/dioxide sensor, other gas/organic compound sensors, a particulate matter sensor/detector, an ozone or radon sensor/detector, a noise detector or microphone, a light sensor, an occupant presence sensor (e.g., passive infrared (PIR) presence sensors), a capacity sensor for sensing a load, a mmWave radar for distance measurements, a magnetic field sensor/detector, a barometric sensor, a hydrogen sensor, an ethanol sensor, a camera for imaging the surrounding environment, an accelerometer for detecting the sensor's movements, a gyroscope for detecting the sensor's orientation, or a combination thereof. Also, the linking devices 136 can include circuits (e.g., a wireless transmitter, receiver, router/modem, etc.) configured to provide wireless connection to one or more user devices (e.g., smart phones, wearable devices, access keys, etc.) and/or provide an interface between the user devices and the control module 102. Further, the linking devices 136 can include circuits configured to facilitate processes for locating wireless/mobile devices, such as by transmitting beacon signals, measuring or calculating signal strengths/delays/Doppler shift/etc., interpolating or filtering the measurements (e.g., a Kalman filter to interpolate signal strength measurements), calculating distance based on the measured or calculated result, and/or performing multilateration. For example, the control module 102 can include a multilaterator, such as a Levenberg-Marquardt Multilaterator (LMM), a multilateration cycle queue (MCQ), etc. for locating the mobile devices.

In some embodiments, the control module 102 can be connected to communication nodes 138 (e.g., wireless routers, network connectors/ports) located in the building 104. The communication nodes 138 can in turn be connected to one or more devices/systems (e.g., the user devices 152, the building subsystems, etc.) via a communication network 103, such as a wired or wireless network, a telephone network, the Internet, a cellular network, etc. As such, the control module 102 can communicate with the one or more devices/systems in the building 104 via the communication nodes 138. In some embodiments, as described above, the linking devices 136 can include the communication nodes 138 or functionalities thereof.

For some embodiments, the control module 102 can be connected to a set of sensors 140 in the building, such as environmental and/or status sensors or detectors separate from the linking devices 136. Examples of the sensors 140 can include temperature sensors, humidity sensors, carbon monoxide/dioxide sensors, other gas/organic compounds sensors, particulate matter sensors, ozone or radon sensors, noise detectors or microphones, light sensors, presence sensors, capacity sensors, mmWave radars, magnetic field sensors, barometric sensors, ethanol sensors, cameras, accelerometers, gyroscopes, etc. Other examples of the sensors 140 can include self-test or status reporting circuits associated with one or more of the building subsystems. In some embodiments, the sensors 140 can include presence sensors 142 configured to detect the presence of one or more persons in a corresponding location or space. Some examples of the presence sensors 142 can include weight or pressure sensors located in or on the building floor, furniture (e.g., chairs and/or desks), etc.

As mentioned above, in some embodiments, the control module 102 can interface with individual occupants of the building 104. For example, the control module 102 can communicate with user devices 152 (e.g., smartphones, wearable devices, laptops, etc.) belonging to or operated by the occupants. The user devices 152 can include or access building control application 154 (e.g., software applications, GUI, etc.) configured to enable the occupants to interact with the control module 102 via their devices. For example, the user devices 152 can include a screen that displays available resources (e.g., office spaces, conference rooms, rental devices or furniture, etc.) or locations thereof, indoor routes to destinations, resource or user billing information, current environment settings, and/or other information associated with the building 104. Also, the user devices 152 can receive desired environmental settings (e.g., desired temperature and/or air flow), requests for resources, or requests for other information associated with the building 104 from the building occupants and communicate them to the control module 102.

In some embodiments, the control module 102 can include or interact with a monitoring network that includes the linking devices 136, the communication nodes 138, the sensors 140 (including the presence sensors 142), the user devices 152 (e.g., via the building control application 154), or a combination thereof. The monitoring network can implement various features, such as for: tracking individual occupants, tracking usage/occupancy/availability of resources, tracking the status/state of various aspects of the environment inside the building 104 or its subsystems, etc. One or more components of the monitoring network and/or the communication network 103 can communicate using ultra-high frequency signals (e.g., a frequency range including or about 2.4 GHz), sub-gigahertz signals (e.g., a frequency range including 850 MHz to 950 MHz), etc. For example, the monitoring network and/or the communication network can communicate wireless signals according to one or more protocols, such as for wireless LAN (e.g., WiFi), cellular communications (e.g., one or more of 2G-5G cellular standards), Internet of Things (IoT) communication mechanism (e.g., NB-IoT, LTE-M, etc.), peer-to-peer or device-to-device communication protocols (e.g., Bluetooth, Near-Field communication (NFC), etc.), and/or other wireless communication mechanisms.

System Components

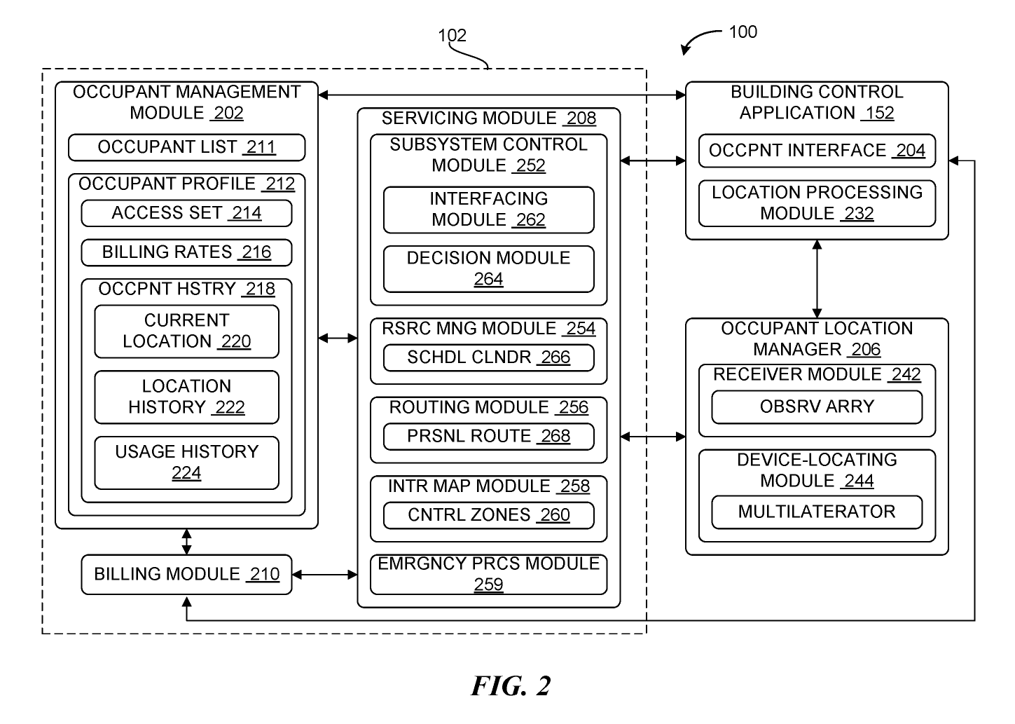

FIG. 2 is a block diagram illustrating various components (e.g., software components, modules, and/or circuits) of a building control and monitoring system (e.g., the building control and monitoring system 100) configured in accordance with some embodiments. In some embodiments, the building control and monitoring system 100 can include an occupant management module 202, a building control application 154, an occupant location manager 206, a servicing module 208, and a billing module 210. The components of the building control and monitoring system 100 can be operatively connected to each other, such as through function calls, communication protocols, etc.

One or more of the components of the building control and monitoring system 100 can be included in or executed by the control module 102 and/or one or more interfaces or APIs implemented on the user devices. For example, one or more of the components can be stored in memory components, executed by one or more processors, and/or implemented by specialized circuits on the system managing devices 112, the user devices 152, the linking devices 136, and/or other devices in the communication network and/or the monitoring network as illustrated on FIG. 1. In some embodiments, the control module 102 can include the occupant management module 202, the servicing module 208, the billing module 210, the occupant location manager 206, a portion thereof, or a combination thereof. The control module 102 can be implemented via one or more of the system managing devices 112. In some embodiments, portions of the control module 102 can be implemented using the building control application 154, the linking devices 136, or a combination thereof. In some embodiments, the user devices 152, the system managing devices 112, and/or the linking devices 136 can implement the occupant location manager 206 or portions thereof.

The occupant management module 202 can be configured to oversee information associated with authorized occupants of the building 104 of FIG. 1. For example, the occupant management module 202 (e.g., one or more databases and/or associated circuits) can maintain an allowed occupant list 211. In some embodiments, the allowed occupant list 211 can correspond to organizations and/or individuals that have a contractual agreement to lease or utilize space(s) in the building 104. The allowed occupant list 211 can further correspond to a member or an employee list for the organization occupying a space within the building 104. Also, the occupant management module 202 can maintain an occupant profile 212 that corresponds to each of the occupants on the allowed occupant list 211. The occupant profile 212 can include various data associated with the corresponding occupant usage and/or access to the building 104, such as an access set 214, one or more billing rates 216, and/or occupant history 218.

In some embodiments, the occupant profile 212 can include the access set 214 that describes a permission given to the corresponding occupant for accessing and/or controlling one or more features, conditions, or resources associated with the building 104. For example, the building occupants may have different levels of control regarding services, access to resources, and/or environmental conditions in the building 104. The occupants with administrative or higher-level access may have settings in the occupant profile 212 that allows them to adjust environmental conditions, such as lighting and/or temperature settings. Also, occupants with lower-level access (e.g., non-administrative members/employees of the leasing organization) may have settings in the occupant profile 212 that allows them to access a set of spaces (e.g., elevators, bathrooms, other spaces within a larger boundary assigned to the occupant organizations, etc.), and/or have limited control over the environmental conditions at their designated/assigned spaces, etc. Also, visitors (e.g., devices or user identifications not included in the allowed occupant list 211) may be given default or limited settings in the occupant profile 212 that control such user access to the building 104. In some embodiments, a visitor may be given limited access to designated spaces, such as lobby areas, a specific floor while using the elevator, a specific conference room, designated bathroom, etc.

In some embodiments, the occupant profile 212 can include the billing rates 216 applicable to the corresponding occupant. The billing rates 216 can include one or more cost parameters (e.g., a financial amount, a usage credit, etc.) associated with the corresponding occupant stay in the building and/or usage of one or more resources thereof. For example, the billing rates 216 can include the occupant utility price, an assigned price associated with adjustments to the environmental conditions, an assigned price for using one or more resources (e.g., a projector, a conference room, a copier, etc.), etc. associated with the building 104. The billing rates 216 can include a mechanism (e.g., a formula, a process, and/or a routine) that dynamically adjusts the prices according to various factors, such as active or real-time demand, external conditions (e.g., weather, temperature outside of the building 104, projected number of renters, other market conditions, etc.), predetermined energy consumption goals, usage or occupancy projection, or a combination thereof.

In some embodiments, the occupant profile 212 can track the occupant history 218. The occupant history 218 can include a record of the corresponding occupant locations within the building 104 and/or usage of one or more resources in the building 104. For example, the building control and monitoring system 100 can determine a current (e.g., in near real-time) location 220 of the corresponding occupant within the building 104. The control module 102 (e.g., the occupant management module 202) can track a location history 222 for the corresponding occupant by storing the occupant current location 220 and/or the corresponding zones (described in more detail below) within the building with a time stamp. In some embodiments, the location history 222 can be tracked anonymously (e.g., using system identifiers instead of occupant identification), such as for path calculation and/or emergency purposes. In other embodiments, the location history 222 can be tracked according to the occupant identification, such as for billing purposes. Also, the control module 102 can track a resource usage history 224 of the occupant based on access events (e.g., sign-on and/or sign-off, scheduling or reservation, and/or other occupant authentication associated with access) associated with the building resources.

The building control application 154 can be configured to provide each occupant with an interface to the building control and monitoring system 100. For example, the building control application 154 can include a user application running on the user device 152 that allows interaction between the control module 102, the building subsystems, and/or the building occupant. The building control application 154 can include an occupant interface 204 that the occupant can use to access one or more system features or records. In some embodiments, the occupant can use the occupant interface 204 to control one or more environmental conditions in the building 104. In some embodiments, the occupant can use the occupant interface 204 to reserve or utilize one or more resources in the building 104. The occupant may also use the occupant interface 204 to access billing-related information (e.g., balances, rates, history, targets or goals, etc.).

In some embodiments, the building control application 154 can include a location processing module 232. The location processing module 232 can include features or functions (e.g., instructions to be implemented by the user devices 152) configured to calculate the current location 220 of the corresponding user device, such as by operating the user device 152 to interact with the monitoring network and/or the control module 102 to locate the user device based on processing signals from known locations. For example, the location processing module 232 can cause one or more wireless receivers to identify one or more beacon or reference signals and/or any associated measurements (e.g., signal strength, phase shift, propagation delay, etc.) for signals transmitted by one or more reference devices in the monitoring network. In some embodiments, the location processing module 232 can include instructions for transmitting the signal measurements and/or other measurements (e.g., from an accelerometer, a gyroscope, a compass, etc. of the device) to the control module 102 (e.g., to the occupant location manager 206). In other embodiments, the location processing module 232 can include instructions for calculating (e.g., using a dead-reckoning mechanism and/or a multilateration mechanism) the current location 220 using the corresponding user device, and for reporting the current location 220 to the control module 102 (e.g., to the occupant management module 202). Also, the location processing module 232 can cause the wireless transmitter of the corresponding user device to transmit a beacon or reference signal, such as at a designated time and/or interval, for the purposes of locating the corresponding user device.

The occupant location manager 206 can be configured to calculate the current location 220 for each of the user devices 152 located in the building 104. The occupant location manager 206 can calculate the current locations (e.g., physical locations of occupants) using multilateration and/or dead-reckoning based on the measurements associated with each of the user devices 152 and/or prior knowledge of the building environment (e.g., the building map 116 including floor plans, location of linking devices, communication nodes, and/or sensors, etc.).

As an implementation example, one or more processes executed by a software application (e.g., the control module 102 or portions thereof) can observe a user location. The processes can send a message or set a flag to receive location updates by creating a localization session. The localization session can be represented by a portion of the occupant location manager 206 configured to receive high-level commands and provide asynchronous updates of the current location of one or more occupants. The occupant location manager 206 can communicate with other devices, such as between the linking devices 136 and the user devices 152, using a wireless communication mechanism (e.g., Bluetooth). The occupant location manager 206 can filter out measurement noise and/or combine locations of reference devices (e.g., beacon transmitters or receivers) to produce location approximations.

In some embodiments, the occupant location manager 206 can include a measurement receiver module 242, a device-locating module 244, or a combination thereof. The measurement receiver module 242 can interact with one or more circuits/modules (e.g., motion or measurement reporting circuit/module) of the user devices 152 to acquire location-based information or measurements. For example, the measurement receiver module 242 can include an observation array (e.g., a specifically-configured data structure) configured to manage signal strength measurements (e.g., received signal strength indicator (RSSI) measurements) made at the user devices 152. The measurement receiver module 242 can receive the signal strength measurements associated with the corresponding user device sending/receiving the beacon signals. The measurement receiver module 242 can record the received measurements in the observation array with time stamps.

In some embodiments, the measurement receiver module 242 can update the observation array to track a set of most-recent locations and/or maintain only validated locations. For example, the observation array can include an active measurement set, which can cache measurements across multiple batch updates of asynchronously arriving signal strength measurements. When a new batch of measurements arrives, the observation array can use beacon identification to pair measurements with a known location of the reference device (e.g., beacon transmitter or receiver). The observation array can also discard unpaired measurements. The pairings, along with the measured signal strengths and its time stamps, can be stored in the active measurement set. If the active measurement set includes measurements associated with the same beacons, the measured signal strengths can be updated, and their respective timestamps can be reset or replaced. In some embodiments, signal strength measurements can be removed from the active measurement set when they are not updated for a predetermined duration to prevent older measurements from influencing newer measurements. The observation array can notify other components whenever the active measurement set is adjusted.

In some embodiments, the measurement receiver module 242 can process the received information using one or more filters (e.g., filters corresponding to linear models, such as Kalman filters). For example, the measurement receiver module 242 can use the one or more filters to interpolate the RSSI measurements with a damping constant to suppress rapid fluctuations in sequentially measured values. Based on the one or more filters, the measurement receiver module 242 can apply different damping constants based on an accelerometer reading of the user device. In some embodiments, the measurement receiver module 242 can apply a first damping constant when the accelerometer output indicates that the user device is stationary, thereby improving the resiliency against random noise. The measurement receiver module 242 can further apply a second damping constant when the accelerometer output indicates that the user is moving, thereby increasing the responsiveness to RSSI fluctuations. The filtered values can be stored in the observation array, such as by replacing the initially received measurements.

The device-locating module 244 can access the measurements and/or their filtered results and calculate the current location 220 of the corresponding user device in the building 104 accordingly. In some embodiments, the device-locating module 244 can include a multilateration mechanism (e.g., a Levenberg-Marquardt Multilaterator (LMM)) configured to locate the user device based on the received measurements (e.g., the signal strength measurements). For example, the multilateration mechanism can subscribe to notifications that represent updates to the observation array. On asynchronous updates, the multilateration mechanism can retrieve the latest information from the observation array and push a cycle request in a multilateration cycle queue (MCQ). The MCQ can process the queued requests and control the sequential initiation and termination of a problem solver in the multilateration mechanism. In some embodiments, the MCQ can cut awaiting requests upon insertion of a new request to prevent overflow. Accordingly, in some embodiments, the MCQ can ensure that the length of the queue is less than a predetermined number, and the system can thereby be responsive to the latest updates. In some embodiments, the device-locating module 244 can operate based on an event-driven model. Initially, the multilateration mechanism can subscribe for update notifications of the active measurement set. At an asynchronous update, the multilateration mechanism can receive the latest active observations from the active measurement set and push a cycle request in the MCQ. On a separate background thread, a control mechanism (e.g., a software function) can process queued requests and control the sequential instantiation and termination of the multilateration mechanism.

In calculating the current location 220, the device-locating module 244 can access the building map 116 of FIG. 1 that includes known locations of reference devices (e.g., one or more devices in the monitor network, such as beacon sources and/or signal receivers). In some embodiments, the linking devices 136 can function as the beacon source. The multilateration mechanism can identify the known locations of the reference devices that correspond to the strength measurements (e.g., the RSSI measurements). Using the measurements (e.g., the RSSI and/or the measured propagation delay), the multilateration mechanism can calculate distances between the user device and the corresponding reference devices. The multilateration mechanism can calculate the current location 220 as the location that matches the calculated distances from the corresponding reference devices. In some embodiments, the multilateration mechanism can further calculate an accuracy measure for the current location 220.

In some embodiments, the device-locating module 244 can store the current location 220 to serve as a prior location later and/or store the processed values (e.g., list of the signal sourcing devices and/or their associated measurements). The device-locating module 244 can prefetch the stored information for updating the current location 220. The device-locating module 244 can further access distance characteristics (e.g., an RSSI-distance characteristic (RDC)) calibration constants and/or the known locations of the previously utilized signal-sourcing/receiving devices. The device-locating module 244 can evaluate (e.g., when the user device 152 first enters the building 102 according to the occupant history 218 and/or at any time while the user device 152 is within the building 102) a calibration using the calibration constant and the measurement values against stored values that were generated during a prior calibration using devices similar (e.g., same make, model, and/or operating system version) to the user device 152. The distance values can be calculated accordingly. In calculating the current location 220, the device-locating module 244 can further filter the set of signals to utilize signals and/or measurements from reference devices that are located within a predetermined distance, such as by ignoring the RSSI measurements that fail to satisfy a threshold.

The device-locating module 244 can interact with the building control application 154 to calculate the current location 220 for each of the user devices 152. In some embodiments, the device-locating module 244 can calculate and/or adjust the current location 220 according to a dead-reckoning mechanism that calculates and combines displacements over time according to accelerometer readings of the corresponding device.

The servicing module 208 can communicate with the occupant location manager 206 and/or the building control application 154. In addition, servicing module 208 can be configured to control one or more aspects of the building 104 according to current locations of the user devices and/or information from one or more of the occupants. The servicing module 208 can receive or access the current locations from the occupant management module 202 and/or the occupant location manager 206, access or receive control inputs or requests from the building control application 154 of one or more of the user devices 152, or a combination thereof.

In some embodiments, the servicing module 208 can include a subsystem control module 252 (e.g., a portion of one or more linking devices 136 and/or the control module 102) configured to interact with and/or control one or more subsystems (e.g., the elevator system 122, the security system 124, the emergency system 126, the energy management system 128, the HVAC system 130, the CAFM 132, the BMS 134, etc., all of FIG. 1) of the building 104. For example, the subsystem control module 252 can include a subsystem interfacing module 262 configured to enable interactions (e.g., query, report, command, etc.) between the corresponding subsystem and the system managing devices 112. In some embodiments, the subsystem control module 252 can include or be implemented by circuits and/or electrical connections (e.g., the linking devices 136) that link a previously stand-alone subsystem to the control module 102. In some embodiments, the subsystem control module 252 can include device/system drivers, application program interface (API), etc. configured to enable or facilitate interactions between the control module 102 and the previously stand-alone or unintegrated subsystem.

Also, the subsystem control module 252 can include an interactive decision module 264 configured to control one or more subsystems based on one or more parameters, such as the current locations, the occupant interactions, or other processing results. The interactive decision module 264 can be configured to control the subsystems to influence one or more aspects of the environmental conditions of the building 104. In some embodiments, the control module 102 can determine control zones where one or more environmental conditions directly respond to a combination of subsystem components and/or settings. The interactive decision module 264 can control the environmental conditions (e.g., ambient temperature, lighting or brightness, air flow rate, etc.) at each of the determined zones according to a user presence in the zones, a user preference, a control input/request, etc. For example, the interactive decision module 264 can control the environment to match the preferred or requested settings from the occupants when they all match or are within a threshold range from each other, or when there is only one occupant in the zone. Also, the interactive decision module 264 can control the environment according to a compromised setting (e.g., an average value, a weighted average according to occupant status or cost-splitting settings, etc.) for environmental conditions when the preferences/requests of occupants in the space differ.

In some embodiments, the servicing module 208 can include a resource management module 254 configured to track use of resources associated with the building 104. For example, the resource management module 254 can coordinate space/resource assignments. The resource management module 254 can receive reservation requests for single occupant spaces (e.g., a cubicle, an office, or a room at a rental facility, such as a workshare space or a hotel), multiple-occupant spaces (e.g., conference rooms) via the occupant interface 204. The resource management module 254 can identify available spaces and filter them according to one or more characteristics (e.g., regarding devices and/or furniture, temperature, lighting, size, location, etc.) of the requested space. Accordingly, the resource management module 254 can assign the occupant space in response to the reservation request. Further, the resource management module 254 can track the location/usage of the requesting occupant based on storing the occupant location and/or interact with the servicing module 208 to provide an indoor route that guides the occupant through the building to/from the assigned space.

In various embodiments, the resource management module 254 can access the occupant profile 212 (e.g., the access set 214) in processing requests (e.g., for reservation and/or for controlling environmental settings). The resource management module 254 can determine a right or authorization of the occupant to make the requests using the access set 214 and process the requests accordingly. For example, the resource management module 254 can ignore or deny the environment setting request from visitors or occupants at non-assigned locations. Also, the resource management module 254 can allow the requesting occupant to book or reserve the spaces where the occupant is allowed to enter (such as, e.g., according to an occupant security level as specified in the access set 214). In some embodiments, when multiple occupants submit overlapping requests (e.g., for controlling the environmental conditions at the same zone or reserving the same space), the resource management module 254 can check the access set 214 of the requesting occupants for authorization levels, such as for administrative personnel or for occupants that subscribed (such as by paying higher fees) to have greater authority than non-subscribing occupants. Accordingly, the resource management module 254 can prioritize (such as by implementing the request in whole or by giving the requested parameters higher weight) the request of the occupant having greater authority.

Also, the resource management module 254 can record the environment setting request along with the time/duration of the request and/or the identification information of the requesting occupant. Also, the resource management module 254 can include a scheduling calendar 266 (e.g., a database, a user interface, etc.) configured to reserve and/or track usage of conference rooms, occupant spaces (e.g., for daily, hourly, or other limited rental services/locations), furniture, devices (e.g., projectors, printers, etc.) provided by and/or stationary in the building 104, etc. The resource management module 254 can track the usage based on recording access or log-in information used to access the resources. The resource management module 254 can interface with the building control application 154 to record requests to reserve resources in the scheduling calendar 266. The resource management module 254 can further interface with the building control application 154 to show availability of resources for scheduling purposes.

In some embodiments, the servicing module 208 can include a routing module 256 configured to calculate routes for individual occupants. For example, in determining available or target resources, such as a newly assigned occupant space or a conference room, the routing module 256 can calculate routes of the occupant to the resources. In some embodiments, the routing module 256 can calculate comparison routes for available resources sought by an occupant to determine the nearest available resource. The routing module 256 can pass the routes and/or qualifying resources (e.g., nearest n resources) to the building control application 154 to inform the occupant. In some embodiments, the routing module 256 can calculate routes for occupants identified as a meeting participant in determining a conference room that would minimize overall travel distance of the participants. In some embodiments, the routing module 256 can calculate personal emergency routes 268 for evacuating the building 104 in emergency scenarios. The routing module 256 can use the sensed information (e.g., CCTV images, gas sensor readings, etc.) to determine the nature and/or location of the emergency (e.g., a fire, a medical emergency, a structural damage, etc.) and direct occupants accordingly. The routing module 256 can further determine the current locations of all occupants and calculate individualized evacuation routes that both avoid the location of the emergency and further provide crowd-control. Accordingly, the routing module 256 can decrease total evacuation time and/or decreasing exposure to dangers for the occupants during the emergency response.

In calculating the routes, the routing module 256 can utilize a combinatorial graph defined by the building map 116, estimated locations of structures/paths, locations or groupings of other occupants, etc. The routing module 256 can identify the pathways as directed edges or connections, and pathway junctions as nodes. Each directed edge can be assigned weights that represent quantities of interest (e.g., travel distance, walk time, etc.). In some embodiments, such as during emergencies, the edge weights may be updated (e.g., by the control module 102) to reflect the current state (e.g., travel speed and/or number of co-located occupants, etc.) of the building. To calculate the route, the routing module 256 can determine a starting location, such as by obtaining the current location 220 of the requesting device or by interacting with the occupant, and then map the starting location to a nearest node or edge. The routing module 256 can further determine a destination (e.g., occupant specified location, qualifying conference room, an emergency exit, etc.). The routing module 256 can use shortest-path calculation mechanism, such as A* mechanism, to calculate a route from the starting location to the destination. The routing module 256 can display the calculated route and/or provide turn-by-turn guidance for the occupant through the user device.

In some embodiments, the servicing module 208 can include an interior mapping module 258 configured to autonomously (e.g., without active or deterministic inputs from a human operator) map static (e.g., columns, walls, cubicle dividers, etc.) or semi-static objects (e.g., larger electronic devices, such as copy machines, refrigerators, etc.) within the building 104. The interior mapping module 258 can further map or locate partition-level structures (e.g., walls, dividers, cubicles, beams or columns, doors, pathways, etc.) within the building 104. For example, the interior mapping module 258 can be provided with (via e.g., user input and/or standard documents, such as blue prints) locations of the devices (e.g., the linking devices 136, the communication nodes 138, the sensors 140, etc.) in the monitoring network and/or the communication network and/or initial layout of the non-movable structures (e.g., walls, support columns, etc.). The interior mapping module 258 can additionally determine pathways based on tracking occupant movements throughout the building 104, such as determining continuous movements or travels across a sequence of locations. For example, the interior mapping module 258 can determine the path as a sequence of locations where, in a given duration, at least a predetermined number of occupants traverse without stopping.

The interior mapping module 258 can similarly use the tracked location to determine occupancy spaces. For example, the interior mapping module 258 can determine the occupancy spaces based on a set of locations where one or more occupants are repeatedly located without any threshold-exceeding movements (e.g., locations clustered within a standardized area size) for more than a predetermined duration. In some embodiments, the interior mapping module 258 can identify clusters of locations using one or more pattern-recognition mechanisms and determine the identified clusters as the occupancy spaces.

Based on the determined occupancy spaces and/or the paths, the interior mapping module 258 can estimate locations of structures or boundaries (e.g., larger office-objects, cubicle dividers, etc.) that likely exists around the determined pathways and/or the occupant spaces. For example, the interior mapping module 258 can include predetermined distances and/or an equation, such as for describing standard path widths and cubicle/office sizes, that determines the locations of the structures/boundaries relative to a center or edge location of the locations readings. The interior mapping module 258 can use the estimated structures and their locations to validate or reinforce the building map 116. In some embodiments, the interior mapping module 258 can periodically compare coordinates of location data (e.g., a recent set of data) to the estimated structures. When the location data overlaps with the location of an estimated structure, the interior mapping module 258 can reinitiate the estimation process.

In some embodiments, the interior mapping module 258 can autonomously determine and/or adjust control zones 260 in which environmental conditions are controlled by a set or a combination of subsystem components (e.g., a thermostat setting, a fan setting, etc.). Each of the control zones 260 can represent a space in which one or more environmental conditions (e.g., temperature) are uniquely affected by a set of controllable conditions, such as a setting for a fan, a heating/cooling coil, a light source, etc. located at one or more specific locations. In some embodiments, multiple separate control zones 260 can coexist within an open area (e.g., common/shared area and/or cubicle areas in an office) that includes multiple occupant spaces. In some embodiments, the control zones 260 can each include multiple occupant spaces. The control zones 260 can further be associated with prediction models that characterize likely environmental changes at and/or around the zones, over time, etc., such as models that predict dispersion of thermal energy over time and the corresponding temperature changes in an area.

In determining the control zones 260 and/or the prediction models, the interior mapping module 258 can track setting changes (e.g., thermostat settings, fan settings, etc.) and sensor measurements (e.g., temperature) over time, such as by storing the commanded settings and their time in a log. The interior mapping module 258 can analyze the tracked information for a pattern (e.g., a cause-and-effect relationship) between the setting changes and environmental changes measured by sensors at known locations. In analyzing the tracked information, the interior mapping module 258 can use an artificial intelligence mechanism, a pattern recognition mechanism, one or more computer-generated models, etc. For example, the interior mapping module 258 can use a clustering algorithm, Bayesian networks, etc., to determine control zones 260. Also, the interior mapping module 258 can use the associated predictive response models that are affected by a combination of controls and other real-time factors to determine the control zones 260. Also, the interior mapping module 258 can use information or models associated with air flow behavior, temperature dissemination characteristics, location/shape of estimated structures (e.g., pathways, walls, divisions, large objects, etc. estimated based on tracked locations of users), or a combination thereof to analyze the tracked information and/or generate the prediction model.

In one or more embodiments, the interior mapping module 258 can implement self-localization of one or more devices (e.g., the linking devices 136, the sensors 140 including the presence sensors 142, the communication nodes 138, or a combination thereof) in the communication network and/or the sensor network. In some embodiments, for example, one or more of the devices can be configured to send and/or receive beacon signals for implementing the self-localization. Upon receiving the beacon signals, the devices can measure one or more characteristics of the received signal (e.g., the RSSI value) and send the measurements to the device-locating module 244. The device-locating module 244 can use the measurements to locate the devices relative to each other. In some embodiments, the device-locating module 244 can use the measurements to locate the devices relative to the building 104 based on known locations of one or more of the devices. In locating the devices relative to each other and/or relative to the building 104, the device-locating module 244 can use one or more of the processes (e.g., RSSI to distance conversion and/or multilateration) described above. The calculated locations of the devices can be passed back to the interior mapping module 258. The interior mapping module 258 can use the calculated locations to verify and/or adjust the building map 116. For example, the interior mapping module 258 can adjust the building map 116 to update the location of the corresponding device (e.g., the linking devices 136, the sensors 140, the communication nodes 138, or a combination thereof) when a predetermined number of consecutive reported locations are different from a previous location of the device.

In some embodiments, the servicing module 208 can include an emergency processing module 259 configured to detect and process emergency events. In some embodiments, the emergency processing module 259 can detect emergency events based on analyzing sensor readings from the linking devices 136, the sensors 140, etc. For example, the emergency processing module 259 can detect an earthquake based on accelerometer readings matching or exceeding one or more thresholds, a fire based on carbon monoxide/dioxide levels or temperature changes matching or exceeding one or more thresholds, identifying a weapon or a gunshot in captured images based on predetermined images/patterns, etc. In some embodiments, the emergency processing module 259 can estimate a direction of the gunshot, such as based on processing the captured image to determine an orientation of the shooter and/or the gun. In some embodiments, the emergency processing module 259 can detect a gunshot based on comparing characteristics of sounds captured by microphones in sensors (e.g., the linking devices 136, the sensors 140, etc.) to predetermined templates or thresholds.

In some embodiments, the emergency processing module 259 can determine one or more locations affected by the emergency event based on a measurement time, a measurement level, or a combination thereof associated with the emergency event. For example, the emergency processing module 259 can estimate a location of the fire based on locating which sensor first measured the temperature, the gases, etc. Also, the emergency processing module 259 can estimate the location of the fire based on a pattern of temperature changes measured across different locations, a pattern of gas detections across different locations, current temperature readings at various locations, etc. Also, the emergency processing module 259 can determine the affected locations based on analyzing CCTV feeds with image recognition mechanisms and predetermined images/patterns. The emergency processing module 259 can further use similar processes to estimate a severity of the emergency event. For example, the emergency processing module 259 can calculate a size of the fire, a spreading rate of the fire, etc. based on the sensor readings.

The emergency processing module 259 can implement a set of protocols associated with the identified emergency event. For example, the emergency processing module 259 can play pre-recorded instructions for the occupants to follow. Also, the emergency processing module 259 can communicate individualized information, such as the personal emergency routes 268 and/or associated turn-by-turn navigation, to each occupant through the user devices 152 and the building control application 154.

The billing module 210 can be configured to calculate costs for the building occupants. For example, the billing module 210 can calculate costs associated with the presence of occupants in the building or at specific locations therein, their use or consumption of resources, energy expenditure associated with the occupants, etc. The billing module 210 can calculate the costs according to various real-time parameters, such as the occupant locations, inputs or requests from the occupants (e.g., via the building control application 154), etc. For example, the billing module 210 can calculate the costs (e.g., based on multiplying the price with the duration) based on determining the occupant locations relative to various rooms or spaces (e.g., entertainment area, window seats, etc.) in the building 104, durations of the occupant stay, and the billing rates 216 for the locations. Also, the billing module 210 can calculate the costs associated with a baseline use, such as by dividing a predetermined total cost of maintaining baseline conditions by a total number of occupants. Also, the billing module 210 can calculate the costs associated with energy expenditures for the control zones 260 and/or the costs associated with the request to adjust one or more conditions in the control zones 260. The billing module 210 can calculate the costs by calculating a deviation from the baseline at the control zones 260, calculating a resource expenditure (e.g., an amount of gas/electricity) associated with the deviation, identifying a unit cost of the resource, and then combining the unit cost, the amount of expenditure, for the duration of the setting. Further, the billing module 210 can calculate the costs using real-time prices/rates and/or demands of the available energy, such as for day-to-day or seasonal gas prices, hourly electricity prices, etc. as listed by the resource provider.

### Linking Device

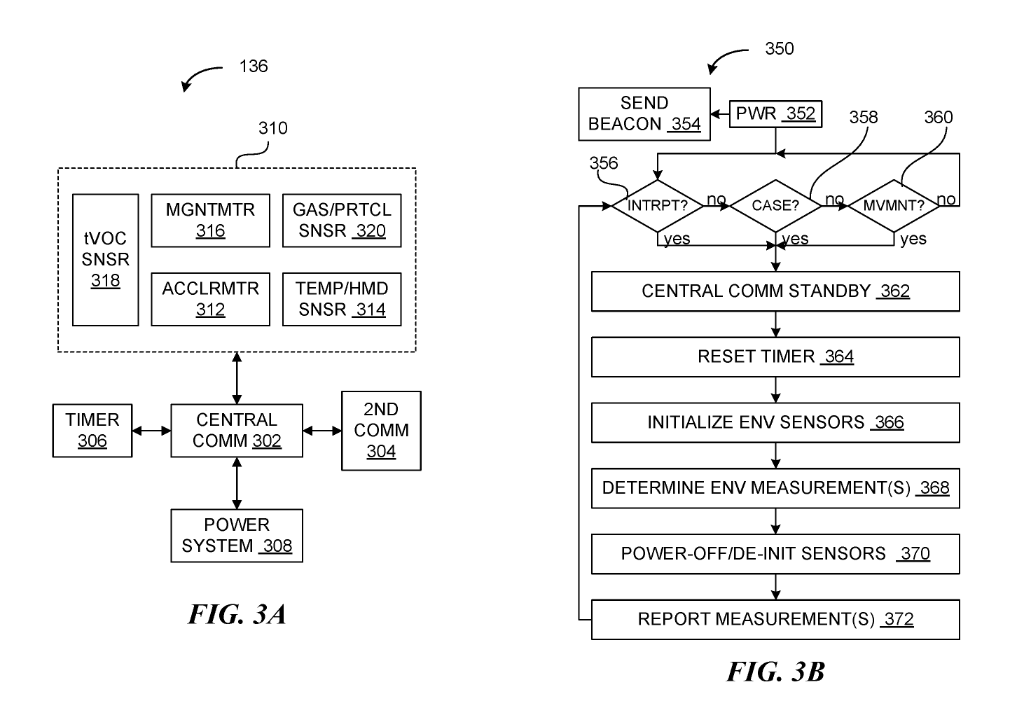

FIG. 3A is a block diagram of a linking device 136 configured in accordance with some embodiments. The linking device 136 can include one or more circuits configured to provide an interface between various devices/systems for a building control and monitoring system (e.g., the building control and monitoring system 100 of FIG. 1). In some embodiments, the linking device 136 can be a surface-mount device including attachment mechanisms (e.g., a mounting portion including an adhesive, a nail, a screw, a cable tie, etc.) configured to attached to a surface of a structure (e.g., a wall, a ceiling, a column, a divider, a floor, etc.) in the building 104 of FIG. 1.

In some embodiments, the linking device 136 can include a central communication circuit 302 connected to a second communication circuit 304, a timer circuit 306, a power system 308, one or more onboard sensors 310, or a combination thereof. In some embodiments, the circuits can be connected using UART connections/bus, direct communication connections (e.g., traces on printed circuit boards), a serial peripheral interface (SPI), an inter-integrated circuit (I2C) communication, and/or other circuit-to-circuit or device-to-device communication mechanisms.

The central communication circuit 302 (e.g., a processor, onboard memory, a transmitter, a receiver, etc.) can be configured to provide an interface (such as, e.g., based on mapping commands, signals, information, etc. according to formats recognized by the connected devices/systems) between the control module 102 and the building subsystems, building occupants (e.g., the user devices 152 of FIG. 1), the environmental sensor 310, or a combination thereof. In some embodiments, the central communication circuit 302 can include a sub-GHz communication circuit, one or more antenna, an Ethernet port/circuit, a wireless LAN connector/circuit, etc. for facilitating the communication between the devices/systems. The central communication circuit 302 can further include a control circuit (e.g., a microcontroller, a processor, etc.) configured to provide initial processing and/or internal control over one or more operably connected circuits.

The second communication circuit 304 can be configured to provide an interface (such as, e.g., by mapping commands, signals, information, etc. according to formats recognized by the connected devices/systems) between the central communication circuit 302, and thereby the control module 102, and one or more building subsystems and/or the building occupants. For example, the second communication circuit 304 can include a wired or wireless direct communication interface/connection to the building systems, such as systems/devices described above. Also, the second communication circuit 304 can include a wireless communication interface (e.g., a Bluetooth interface, a wireless LAN interface, antenna, etc.) configured to interface/connect to the user devices 152.

The timer circuit 306 can be configured to facilitate an operating cycle for the linking device 136. The timer circuit 306 can provide an interrupt at one or more predetermined intervals (e.g., various timing/accuracy modes) for operating one or more circuits in the linking device 136. In some example embodiments, the timer can provide an interrupt signal every 15 minutes that initiates sensor measurement and reporting of the sensor measurement. Once the environmental measurements have been made and reported, the linking device 136 can power down one or more circuits or cause them to stay in standby mode until the next interrupt, thereby reducing power consumption. In some embodiments, the functions of the timer circuit 306 can be included in or shared with other circuits, such as the onboard sensors 310. For example, the onboard sensors 310 in standby mode can generate the interrupt to initiate reporting of the sensor measurements. As an illustrative example, the temperature-humidity sensor 314 can be configured (via, e.g., coarser measurement circuit, a temperature-based breaker, and/or reduced sampling frequency) to monitor the ambient temperature for one or more extreme conditions while in standby mode. When the temperature-humidity sensor 314 senses an extreme condition (e.g., a fire as represented by a temperature reading exceeding a corresponding threshold), the temperature-humidity sensor 314 can generate the interrupt to initiate the reporting process. Details regarding the operating sequence and the timer circuit 306 are discussed below.

In some embodiments, the power system 308 can include one or more batteries or a connection to a building power system, a power control circuit (e.g., a voltage regulator), etc. configured to power the circuits within the linking device 136. In some embodiments, the power system 308 can include a transformer that provides 3.3V for powering the internal circuits of the linking device 136. The output from the battery can be set to the output of the voltage regulator when the battery voltage falls below 3.3V.

The linking device 136 can include the onboard sensors 310 configured to determine corresponding environmental conditions in the building 104. In some embodiments, the onboard sensors 310 can include an accelerometer 312, a temperature and/or a humidity sensor 314, a magnetometer 316, a total volatile organic compounds (tVOC) sensor 318, a gas or particle sensor 320, etc. In some embodiments, the onboard sensors 310 can further include other sensor circuits, such as a camera, an ambient noise detector, a light sensor, a presence sensor (e.g., passive infrared (PIR) presence sensors), a capacity sensor, a mmWave radar, a barometric sensor, a gyroscope, or a combination thereof. In some embodiments, the linking device 136 can include a modular design that can be configured to include a different combination of sensors, communication circuits, etc. In some embodiments, the linking device 136 can include a user interface circuit configured to directly communicate with building occupants. For example, the linking device 136 can include a camera for receiving motion commands, a microphone for receiving voice commands, a touch-interface, etc.

FIG. 3B is a flow diagram illustrating an example process 350 for operating the linking device 136 of FIG. 3A according to some embodiments. As illustrated in FIG. 3B, the process 350 is associated with measuring the environmental conditions in the building 104 of FIG. 1 and reporting them to the control module 102 of FIG. 1. The process 350 can initiate with a power-on/initialization event as illustrated at block 352. Once the linking device 136 initializes, at block 354, the linking device 136 (e.g., the central communication circuit 302, the second communication circuit 304, etc. as shown in FIG. 3A) can regularly broadcast beacon signals. For example, the linking device 136 can transmit a beacon frame (e.g., based on one or more wireless communication protocols, such as Bluetooth) according to a predetermined interval (e.g., 200 ms) during operational state of the linking device 136.

At decision block 356, the linking device 136 (e.g., via the timer circuit 306 of FIG. 3A and/or the onboard sensors 310) can determine whether an interrupt has occurred, such as generated by the timer circuit 306 according to a predetermined interval (e.g., 15 minutes) or by one or more of the onboard sensors 310 as described above. At decision block 358, the linking device 136 (via e.g., a connection/continuity circuit) can determine whether its outer case is open or compromised. At decision block 360, the linking device 136 (e.g., the accelerometer 312 of FIG. 3A) can determine whether the linking device 136 has moved or is moving, such as by identifying an accelerometer reading that exceeds a threshold magnitude. If none of the tested events have occurred (e.g., the timer has not expired, the case has not been opened, and the device has not moved), the process 350 can repeat, such as by looping through decision blocks 356, 358, and 360.

At block 362, if the interrupt event has occurred, if the case has been opened, and/or if the device has moved, the central communication circuit 302 of FIG. 3A can be initialized. For example, the central communication circuit 302 can transition from a shutdown state to a standby state. At block 364, the timer circuit 306 can be reset (e.g., counter value set to 0). At block 366, the onboard sensors 310 of FIG. 3B can be powered on and/or initialized. At block 368, the linking device 136 can measure, after a settling delay in some embodiments, the conditions of the surrounding environment using the onboard sensors 310 (e.g., the temperature-humidity sensor 314, the magnetometer 316, the tVOC sensor 318, the gas-particulate sensor 320, etc.). Once the measurements of the conditions have been made, at block 370, the linking device 136 can power-down or de-initialize the sensors or switch to a standby mode. In some embodiments, the central communication circuit 302 can receive and/or store, such as using onboard memory, a temperature measurement and/or a humidity measurement from the temperature/humidity sensor 314. Afterwards, the temperature/humidity sensor 314 can be powered off. Also, the central communication circuit 302 can receive and/or store one or more measurements from the other sensor circuits. Subsequently, the sensor circuits can be powered off or de-initialized to reduce power consumption.

At block 372, the linking device 136 (e.g., the central communication circuit 302) can report the received sensor measurements to the control module 102. In some embodiments, the linking device 136 can further perform a status check, such as for evaluating battery power, and report the status to the control module 102. The linking device 136 can power-off or de-initialize the remaining circuits (e.g., the central communication circuit 302) after the measurements have been reported. Accordingly, while the power remains at sufficient levels, the linking device 136 can wait for another wake up event, such as represented by the decision blocks 356-360.

Processing of Information Associated with Internal Spaces within a Building

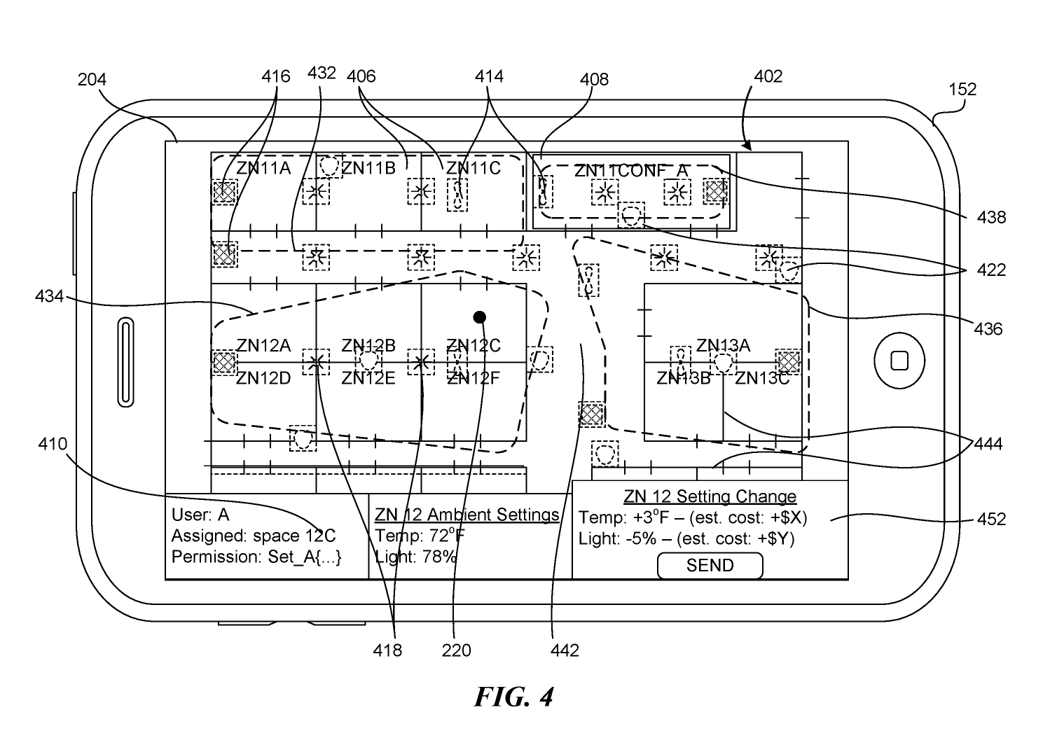

FIG. 4 illustrates an example user device 152 of FIG. 1 having the occupant interface 204 of FIG. 2 according to some embodiments. For example, the building control application 154 of FIG. 1 can cause the user device 152 to implement the occupant interface 204 to show a floor map (e.g., a portion of the building map 116 of FIG. 1) of a unit space 402 in the building 104 of FIG. 1. The unit space 402 can include a portion of the space within the building 104 that is enclosed (e.g., surrounded by walls) and/or corresponds to a single organization/group, purpose, or renter. In some embodiments, the unit space 402 can correspond to an office space rented by an organization, a shared workspace, or a coworking space. In other embodiments, the unit space 402 can correspond to residential spaces, etc.

The floor map can illustrate actual and/or estimated locations of various features, objects, and/or occupants in the building 104. For example, the floor map can display locations of single-occupant spaces 406 and/or multi-occupant spaces (e.g., a conference room 408) for a shared workspace. In some embodiments, the occupant interface 204 can be used by a device user to reserve and/or assign one of the single-occupant spaces 406 and/or the conference room 408 for an occupant via the resource management module 254 as described above. For example, as described above, the resource management module 254 can assign an assigned space 410 to an occupant based on the occupant reservation request and availability of the requested space. Also, in some embodiments, the occupant interface 204 can calculate the current location 220 via the occupant location manager 206 as described above and further display the current location 220 via the building control application 154 as an estimate of the real-time location of the occupant.

In some embodiments, the building map 116 can include locations of components (e.g., HVAC fans, AC vents, thermostats, etc.) of environmental control devices/systems (e.g., the HVAC system 130) and/or sensors (e.g., the linking devices 136 and/or the sensors 140). The building map 116 can thus include locations of energy inputs or influences that affect the environmental conditions within the building along with locations of devices that can measure the resulting environmental conditions. For example, as shown using small-dashed lines in FIG. 4, the building map 116 can include component locations, such as for HVAC source locations 414 (e.g., fans, thermostats, heating/cooling element, etc.), HVAC vent locations 416, light source locations 418, etc. The building map 116 can further include sensor locations 422 that represent known locations of the communication nodes 138, the sensors 140, the linking devices 136, etc., which are all illustrated in FIG. 1.

The building map 116 can further include one or more control zones (e.g., a first control zone 432, a second control zone 434, a third control zone 436, etc.). Each control zone (illustrated using long-dashed lines in FIG. 4 for its boundaries) can include an open or connected space within the unit space 402 (e.g., within its outer boundaries). In each control zone, the environmental conditions can be directly affected by a unique combination of subsystem components and their settings. For example, the control zones can include a portion of a common or open area (e.g., as defined by office/room walls), a set of single occupant spaces (e.g., a set of cubicles), etc. that correspond to one or more specific HVAC sources. As illustrated in FIG. 4, the temperature and/or the air flow at the first control zone 432 can be controlled using an HVAC source (via e.g., varying a setting for a thermostat and/or a fan) and an HVAC output vent (via e.g., controlling an opening size/setting) in zone 11. Likewise, temperature and/or the air flow at the second control zone 434 can be controlled using an HVAC source and an HVAC vent located in zone 12. The temperature and/or the air flow at the third control zone 436 can be controlled using a set of HVAC sources and HVAC vents in or about zone 13. The control zones can correspond to a specific setting, and thus may change in size and/or shape according to the component settings (e.g., a fan speed, a heating/cooling element setting, etc.). In some embodiment, the control zones can correspond to temperature gradients and/or models that account for conditions at adjacent zones.

The building map 116 can further include enclosed zones 438 that correspond to spaces within the unit space 402 that are further enclosed or separated from the open area. For example, the enclosed zones 438 can correspond to private offices, privacy rooms, conference rooms, etc. that have its own set of walls and doors. As illustrated in FIG. 4, the enclosed zone 438 for the conference room in zone 11 can correspond to an HVAC source and an HVAC vent located in the conference room.

In some embodiments, the control module 102 can track the current location 220 of one or more mobile devices (e.g., the user devices 152) over time. For example, the control module 102 can store the current location 220 with corresponding time stamp to determine the location history 222 of FIG. 2 of each user device. Using the location history 222 of one or more devices, the control module 102 can estimate pathways 442 (e.g., corridors, walkways, hallways, etc.) that occupants can traverse to and/or from the various occupant spaces. For example, the control module 102 can estimate the pathways 442 as portions of the space that include a sequence of locations that are determined within a movement-determination threshold (e.g., representative of an occupant walking). Also, the control module 102 can estimate the pathways 442 when one or more users traverse through the determined space with a predetermined frequency and/or more than a threshold number of occurrences over a predetermined period. In some embodiments, the control module 102 can use information provided by one or more occupants and/or building administrators.

In some embodiments, the control module 102 can estimate structure locations 444 that represent locations of larger objects (e.g., cubicle dividers, machines, etc.) placed in the unit space 402 and/or structures (e.g., walls, columns, etc.) connected to or integral with the building 102. In some embodiments, as described in detail below, the control module 102 can estimate structure locations 444 based on the pathways 442, temperature changes that occur after activation/setting changes at the HVAC source 414, information from occupants or building administrators, etc. For example, the control module 102 can estimate the structure locations 444 for walls or dividers bordering or defining the estimated pathways 442 based on a template size or location of pathways and/or relative locations of the boundaries. Also, the control module 102 can estimate the structure locations 444 to be between an HVAC source location and a sensor location when the sensor at the location does not respond to activation of the HVAC source within a predetermined threshold duration.

The control module 102 can determine or adjust the control zones (e.g., by altering the zone boundaries) according to the pathways 442, the structure locations 444, etc. For example, the control module 102 can account (e.g., using one or more time-based computer models) for effects of physical structure on dispersion of thermal energy according to the estimated locations of the pathways 442, the structure locations 444, etc. The control module 102 can use models that characterize change in temperature over time to adjust the control zones.

In some embodiments, the control module 102 can interact with an occupant through the building control application 154 to receive an environment setting request 452. The occupant can use the environment setting request 452 to adjust one or more environmental conditions, such as brightness, temperature, etc. at a particular location (e.g., at the control zone that includes the current location 220). In some embodiments, such as when the requesting occupant is alone in the control zone or when other occupants therein agree or permit the request, the control module 102 can adjust the environmental condition to match the request. In some embodiments, the control module 102 can adjust the environmental condition to a level that is between an ambient setting and the requested setting. For example, the control module 102 can adjust the environmental condition to a weighted average that places higher influence on occupants that paid for a higher influence and/or assigned occupants. In some embodiments, the environment setting request 452 can correspond to preference settings identified in the occupant profile 212 of FIG. 2. With regards to the example illustrated in FIG. 4, upon receiving the environment setting request 452 from the occupant, the control module 102 can determine that the current location 220 associated with the occupant is within the second control zone 434. Accordingly, the control module 102 can adjust the environmental conditions at the second control zone 434 in response to the environment setting request 452 from the occupant.

### Flows for a Building Control and Monitoring System

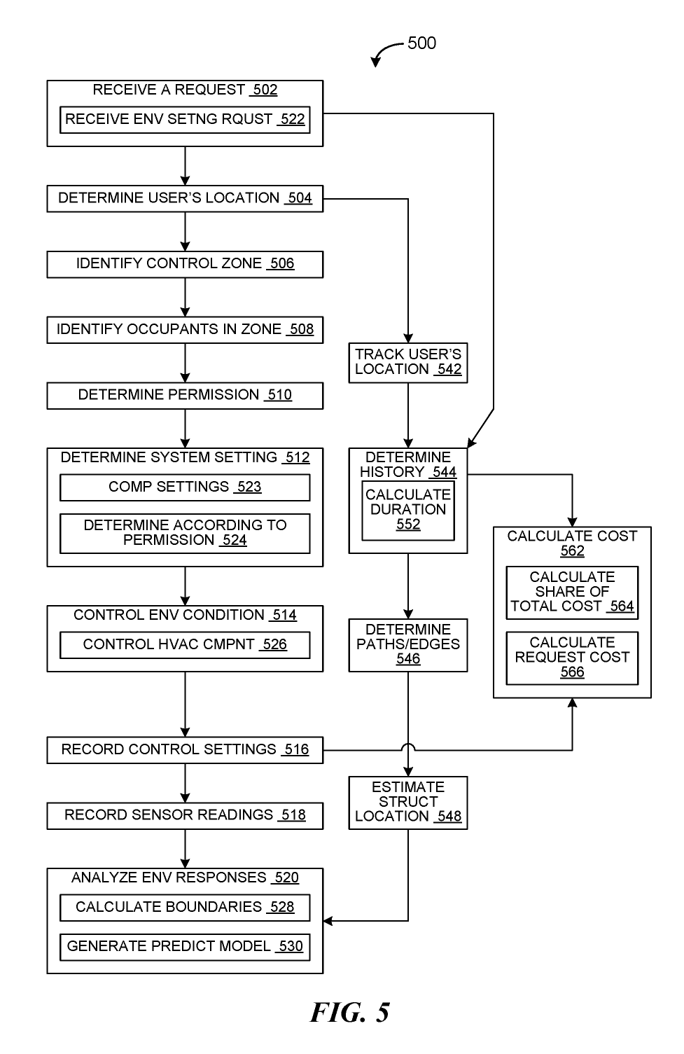

FIG. 5 is a flow diagram illustrating an example process 500 for implementing a building control and monitoring system (e.g., the building control and monitoring system 100 of FIG. 1 or a portion thereof) according to some embodiments. The process 500 can be implemented via one or more devices illustrated in FIG. 1, such as the user devices 152, the system managing devices 112, the linking devices 136, or a combination thereof. The process 500 can be implemented using the modules/components illustrated in FIG. 2, the occupant interface 204 of FIG. 2, the system management interface 114 and/or the control module 102 of FIG. 1, or a combination thereof.

At block 502, the building control and monitoring system 100 (e.g., the subsystem control module 252 of FIG. 2) can receive a request (e.g., the environment setting request 452 of FIG. 4) from an occupant to adjust or control an environmental condition. For example, at block 522, the building control and monitoring system 100 can receive the environment setting request 452 that includes a request to change a temperature or an air flow. In communicating the request, the occupant interface 204 can be utilized to receive the settings from the occupant. The user device 152 can format the received information into the environment setting request 452 and send it to the system managing devices 112 through the linking devices 136, the communication nodes 138, other components in the communication network, etc.

In some embodiments, the building control and monitoring system 100 can generate (e.g., without direct input from the occupant) the environment setting request 452 based on previously received preferences. For example, instead of requiring the occupant (e.g., an employee of an organization renting the space/building, an occupant having a lease term exceeding a threshold, etc.) to submit their settings each time they enter the building 104, the control module 102 can store the occupant preference in the occupant profile 212 of FIG. 2. When the occupant enters their assigned space or a certain zone, the control module 102 can autonomously generate the environment setting request 452.

At block 504, the building control and monitoring system 100 can determine the occupant location. The building control and monitoring system 100 can determine the occupant location based on one or more triggers, such as in response to receiving the environment setting request 452 or as part of periodically (e.g., according to predetermined intervals) calculating/updating the current locations of all occupants within the building 104. In calculating a current location (e.g., the current location 220) representative of an occupant, the building control and monitoring system 100 can interact (via, e.g., the building control application 154 and/or the occupant location manager 206) with the occupant mobile device (e.g., the user device 152, such as a wearable device or a smart phone). In some embodiments, the user device 152 can calculate its own location (e.g., based on the multilateration process described above) and send the current location 220 to the control module 102. In some embodiments, the linking devices 136 and/or the communication nodes 138 can regularly transmit beacon or reference signals for locating mobile devices. The user devices 152 can detect the various beacon signals and measure a characteristic (e.g., signal strength, such as for RSSI, a transmission delay, etc.) of the signal that is affected by a transmission distance.

In some embodiments, the user devices 152 can send the measured characteristics to the control module 102 (e.g., the system managing devices 112, the linking devices 136, etc.), which can use the information to calculate the current location 220, such as based on calculating distances using the measured characteristics, mapping the distances to known locations of the transmitting devices, and solving for a multilateration solution. In some embodiments, the user devices 152 can calculate an intermediate result (e.g., distance estimates) based on the measured characteristics and send the intermediate result to the control module 102. In some embodiments, the user devices 152 can access the building map 116 of FIG. 1 or portions thereof and calculate the current location 220 using the building map 116 and the measured characteristics.

The current location 220 of a mobile device can be calculated using a multilateration mechanism (e.g., using a multilaterator, such as a Levenberg-Marquardt Multilaterator (LMM), a multilateration cycle queue (MCQ), etc.). For example, the characteristics measured at the mobile device can be used to estimate separation distances between the mobile device and corresponding reference devices (e.g., the linking devices 136, the communication nodes 138, etc.) that transmitted the detected beacon signals. The distance estimates can be combined with known locations of the beacon transmitters, such as indicated in the building map 116, to calculate the current location 220 of the user device. In some embodiments, the measured characteristics can be filtered (e.g., using one or more damping constants) based on device acceleration data as described above.

At block 506, the building control and monitoring system 100 can identify the control zone (e.g., the first control zone 432, the second control zone 434, the third control zone 436, etc. as illustrated in FIG. 4) that is associated with the request. For example, the control module 102 can identify a location (e.g., an occupant space identifier, a room identifier, etc.) specified in the environment setting request 452. Also, in response to the temperature adjustment request, the control module 102 can identify the temperature control zone in the building that includes the current location 220 of the device that sent the request. The control module 102 can identify the applicable control zone based on comparing the current location 220 to the boundaries of the various control zones in the building 104, such as identified by the building map 116.

At block 508, the building control and monitoring system 100 can identify other occupants currently located in the applicable control zone (e.g., the control zone that includes the location associated with the request). As described above, the control module 102 can calculate the current locations of all applicable mobile devices in the building 104 according to a predefined frequency. The control module 102 can compare the device locations to locations of zone boundaries to determine the control zones in which each occupant/visitor is located. Accordingly, the control module 102 can look up the applicable control zone to determine the devices, and thereby the corresponding occupants/visitors, that are likely located in the applicable control zone when the request is received.

At block 510, the building control and monitoring system 100 can determine permission/access level of people located in the control zone associated with the received request. For example, the control module 102 can determine the occupants located in the applicable zone (e.g., based on comparing the current location 220 with the determined locations of the zone boundaries) and having assigned spaces therein. Also, the control module 102 can determine the occupants that are currently located in the applicable zone but have an assigned space at another location. The control module 102 can determine visitors located in the applicable zone that do not have any assigned space within the building 104 or applicable portions thereof. For the occupants located in the applicable control zone, the control module 102 can access their occupant profiles, such as the access set 214 of FIG. 2 that specifies authorization given to each occupant for controlling the environmental conditions at the applicable control zone.

At block 512, the building control and monitoring system 100 can determine one or more system component settings 523 that correspond to the environment setting request 452. In responding to the request, the control module 102 can determine specific settings for a combination of subsystem components for operating the subsystem to adjust the environmental condition at the applicable control zone. For example, the control module 102 can determine the component settings 523 such as a fan speed, a thermostat setting, a heating and/or a cooling level, etc. for one or more fans, vents, heating elements, cooling elements, etc. of the HVAC system 130 of FIG. 1 according to one or more computing models (e.g., models generated using one or more machine-learning mechanisms), a predetermined look-up table, an equation, or other mechanisms that are configured to identify the component settings for a desired condition.

In some embodiments, such as illustrated at block 524, the building control and monitoring system 100 can determine the system component settings 523 according to authorization and/or status of the occupants and/or visitors in the applicable control zone (i.e., the processing results generated at block 510). For example, the control module 102 can determine the system component settings 523 that target or achieve the requested condition when the requesting device belongs to a registered occupant authorized to control the temperature for the applicable zone, such as according to the access set 214. Also, the control module 102 can determine the system component settings 523 that target or achieve the requested condition when the requesting occupant is the only occupant located in the applicable control zone.

When there are more than one authorized occupants located in the zone, the control module 102 can determine the system component settings 523 based on averaging the preferences or submissions from other users with the requested conditions. In some embodiments, the control module 102 can determine the system component settings 523 based on a weighted average, where the weights correspond to a purchased service level, a size of the assigned space, or other control level associated with the access set 214 for each occupant in the applicable zone. For example, occupants having assigned spaces in the applicable zone can be given higher weights than occupants that have assigned spaces elsewhere. In some embodiments, the control module 102 can access a threshold range (e.g., as identified in the occupant profile 212) for each occupant in the applicable zone and determine the system component settings 523 that satisfy the ranges of the occupants. For example, each occupant can identify a range of temperature as their comfort zone and/or short-term allowances (e.g., a range of temperature that the occupant is willing to tolerate for a limited amount of time). Accordingly, the control module 102 can determine the system component settings 523 that are within the comfort zones of the occupants and that satisfy/are closest to the requested environmental conditions.

When the environment setting request 452 is submitted by or autonomously generated on behalf of a visiting occupant having the assigned space 410 outside of the applicable zone, the control module 102 can determine the system component settings 523 similarly as described above. For example, the control module 102 can determine the system component settings 523 based on a weighted average, the identified comfort zones and/or the short-term allowances of the occupants assigned to the applicable zone, etc.

At block 514, the building control and monitoring system 100 can control the environmental conditions at the applicable zone, such as by implementing the system component settings 523. For example, the control module 102 can communicate (e.g., via a request or a command) the system component settings 523 that specify components and their settings to the applicable subsystem, such as the HVAC system 130. Upon receiving the system component settings 523, the subsystem can operate the specified components according to the settings to control the environmental condition based on the environment setting request 452.

Based on the control zones, the building control and monitoring system 100 can provide occupant-specific or localized environment controls within an open area in the building 104. The building control and monitoring system 100 can enable individual occupants to request or initiate changes to the environment conditions at their current location. At block 526, the building control and monitoring system 100 can operate a specific set of subsystem components to establish a targeted condition at specific locations (e.g., temperature, air flow, etc.) according to the various control zones.

In some embodiments, the control module 102 can include components or submodules (e.g., the interior mapping module 258 of FIG. 2) configured to autonomously detect any updates or changes in the layout within the building 104. For example, the interior mapping module 258 can adjust boundaries of the control zones and/or generate or adjust prediction models for conditions in the control zones based on analyzing system settings and environmental conditions. In some embodiments, the interior mapping module 258 can autonomously detect any updates or changes separately from or in parallel with other components or submodules (e.g., the servicing module 208, the occupant location manager 206, etc., as illustrated in FIG. 2) of the control module 102.

At block 516, the building control and monitoring system 100 can record the system control settings with a time stamp. For example, in a system log, the interior mapping module 258 can record the system component settings 523 with a time stamp that corresponds to the communication to the subsystem or a confirmation reply from the subsystem. In some embodiments, the interior mapping module 258 can record the identity of the requesting occupant in the log, which a different component (e.g., the occupant management module 202 of FIG. 2) of the control module 102 can use to generate the resource usage history 224 for the occupant.

At block 518, the building control and monitoring system 100 can record sensor readings according to the measurement times. For example, in an environment-tracking log, the interior mapping module 258 can record the measurement values (e.g., temperature measurements) communicated by the monitoring network (e.g., the linking devices 136, the communication nodes 138, the sensors 140, the user devices 152, etc.) along with the time of measurement/reception.

At block 520, the building control and monitoring system 100 can analyze the recorded data to determine environmental responses and their locations. For example, such as illustrated at block 528, the interior mapping module 258 can calculate boundaries that define the control zones. In calculating the boundaries, the interior mapping module 258 can use a machine-learning mechanism, an artificial intelligence mechanism, a pattern recognition mechanism, etc. to identify locations in the building that may be responding to settings of subsystem components. In some embodiments, the interior mapping module 258 can use unsupervised learning mechanisms, such as by identifying cluster of locations where the environmental conditions respond to changes in the settings of one or more components. In some embodiments, the interior mapping module 258 can use supervised learning mechanisms that use validated measurements and/or test/calibration measurements as training data to further identify the locations where the environmental conditions respond to changes in the component settings. The interior mapping module 258 can calculate the boundaries by identifying an outline of the identified locations (e.g., where the environmental conditions likely respond to changes in the settings of one or more components) to establish the control zones and their corresponding subsystem components and/or their settings.

Also, as illustrated at block 530, the interior mapping module 258 can use the recorded data to generate prediction models that predict the change in the environmental conditions over time at the corresponding control zone using one or more machine-learning mechanisms (e.g., supervised or unsupervised learning mechanisms). For example, the prediction models can characterize a change in the environmental condition over time, such as for characterizing a time delay in the response, a rate of change in the conditions, a change in the locations or size of the affected area (e.g., such as due to corresponding energy dispersing across space over time), etc. The interior mapping module 258 can generate the prediction models that characterize the change based on at least an initial setting, a degree of change in setting, a targeted condition, a number of people and/or active devices in the control zone, locations of the occupants in the control zone, or a combination thereof. In some embodiments, the interior mapping module 258 can generate the prediction models based on determining sets of rules that correspond to one or more patterns, clusters, etc. using a supervised learning mechanism (e.g., Regression Analysis, Neural Networks, Support Vector Machines (SVM), Decision-tree learning, etc.) to analyze training data (e.g., initial test runs or post-deployment samples). The training data can consist of component setting values and sensor readings that follow the implementation of the component setting values.

Once the control zones and/or the prediction models have been established, the interior mapping module 258 can verify the zone boundaries and/or the prediction models. For example, the interior mapping module 258 can calculate a prediction at a specific location and/or compare the sensor readings to the corresponding zone and/or model according to a predetermined frequency. When the established control zones and/or the predictions models successfully (e.g., within a predetermined error/acceptance threshold) predicts or characterizes the changes to an implemented component setting, the interior mapping module 258 can process the result as a validation for the established zone/model. When the established control zones and/or the predictions models fail, the interior mapping module 258 can trigger the one or more mechanisms described above to re-calculate or adjust the boundaries, re-generate or adjust the prediction models, etc.

Based on analyzing the component settings and environmental conditions across time, the building control and monitoring system 100 can determine specific locations or control zones that respond to specific component settings. Accordingly, the building control and monitoring system 100 can provide localized control of environmental conditions (e.g., temperature, air flow, etc.) in an open area. For example, the building control and monitoring system 100 can use the control zones to create within an open area pockets of space that have different temperature levels. Further, based on analyzing the component settings and environmental conditions across time, the building control and monitoring system 100 can autonomously detect structural changes (e.g., tenant improvements, cubicle reconfigurations, seasonal or promotional decorations, etc.) to the analyzed space. The detection can trigger the building control and monitoring system 100 to autonomously adjust the control zones and/or the prediction models, thereby autonomously accounting for changes in the space without an updated floor plan or other direct human input.

In some embodiments, the control module 102 can include components or submodules (e.g., the occupant management module 202 and/or the interior mapping module 258 illustrated in FIG. 2) configured to estimate locations of various structures in the building 104. For example, the occupant management module 202 can track the location of the occupants and/or their usage history 224. Also, the interior mapping module 258 can use the tracked locations to estimate or determine map components, such as paths and occupant spaces, which can be further used to estimate locations of structures or objects (e.g., walls and dividers) in the building 104 as described above for the interior mapping module 258. In some embodiments, the control module 102 can estimate the locations of structures when the building map 116 or initial information is missing or incomplete. In some embodiments, the control module 102 can estimate the locations of structures to validate the provided information and/or adjust the provided information, such as based on tenant improvements or changes to the interior space.

At block 542, the control module 102 (e.g., the occupant management module 202) can track occupant locations. For example, the occupant management module 202 can track an occupant location based on storing the current location 220 associated with each occupant along with a time stamp in a data structure or a database. At block 544, the control module 102 can group the stored locations according to the occupant to determine their location history 222 of FIG. 2. Further control module 102 can store the environment setting request 452 and the received time according to the occupant to determine their usage history 224.

In some embodiments, such as illustrated at block 552, the control module 102 can calculate a duration associated with the occupant stay at a location and/or a duration associated with their resource usage/consumption. For example, the control module 102 can calculate the occupant stay duration based on identifying a displacement that exceeds a threshold distance/pattern, and then calculating a difference in the time stamps between the qualifying locations. Also, the control module 102 can calculate the occupant usage/consumption duration based on identifying a change in the subsystem component setting, such as after the environment setting request 452 has been implemented, and then calculating a difference in the time stamps between the qualifying events.

At block 546, the control module 102 can determine or estimate path-calculation components (e.g., paths/edges, junctions/nodes, occupancy space, etc. used to calculate internal travel routes) based on the tracked history. For example, as described above, the interior mapping module 258 can determine a path or a map edge as a sequence of locations where, in a given duration, at least a predetermined number of occupants traverse without stopping. Also, the interior mapping module 258 can determine the occupancy spaces, such as by determining a set of locations where one or more occupants are repeatedly located without any threshold-exceeding movements for more than a predetermined duration. Further, the interior mapping module 258 can determine the occupancy spaces as the detected occupant locations while the environmental settings are controlled according to the occupant request (e.g., according to the resource consumption or usage time and/or duration).

At block 548, the control module 102 can estimate locations of one or more building structures (e.g., structures integral with or attached to the building, such as walls or dividers, and/or any obstructions to physical movements) based on the estimated path-calculation components. For example, the control module 102 can use building codes or templates that define path widths to estimate locations of walls or dividers that run parallel to the estimated paths. Also, the control module 102 can estimate locations of walls or dividers that surround each occupant space based on using a template or a predefined shape and/or measuring a predetermined distance around a distribution of detected locations.

The estimated structures and their locations can be stored as or updated in the building map 116. In some embodiments, the control module 102 can periodically test the estimated structure locations based on comparing more recently determined device locations with the map data. When the recently determined locations satisfy the estimated structure locations, the control module 102 can validate the estimated structure locations accordingly. When the recently determined locations do not satisfy the estimated structure locations, the control module 102 can re-initiate the map element and structure estimation process (e.g., blocks 544-548) using a new set of data (e.g., more recent set of tracked locations).

In some embodiments, the process for analyzing environmental responses (e.g., as illustrated in block 520) can access and utilize the building map 116. For example, the control module 102 can calculate the control zone boundaries and/or generate the prediction model based on the locations of paths, nodes, occupant spaces, and/or structures. The control module 102 can use models, equations, and/or patterns that describe the influences in environmental conditions or changes thereof caused by the map components and/or the structures.

In some embodiments, the control module 102 can include components or submodules (e.g., the billing module 210 of FIG. 2) configured to calculate a cost or a fee associated with occupancy and/or use of facilities or resources of the building for each of its occupants. For example, as illustrated in block 562, the billing module 210 can calculate a cost for the occupants. The billing module 210 can calculate the cost for each occupant by applying one or more billing rates 216 of FIG. 2 to the stay duration according to the occupant location history and/or resource usage.

In some embodiments, such as illustrated at block 564, the billing module 210 can calculate cost or share for each occupant based on calculating a total expenditure (e.g., a cost) for establishing or maintaining environment conditions (e.g., a base or standard ambient temperature) at each of the control zones. The billing module 210 can determine the share or contribution for each occupant in the total expenditure at the control zones, such as according to a ratio between the occupant stay duration and a total occupancy time across all occupants.

In some embodiments, such as illustrated at block 566, the billing module 210 can calculate each the cost or share for each occupant according to their environment setting request 452. For example, if the building control and monitoring system raised the ambient temperature at a control zone in response to a set of requests, at least a portion of the additional cost associated with the higher temperature (e.g., in comparison to a baseline or default ambient temperature) can be charged to the requesting occupant(s).

Based on tracking the occupancy durations and/or control requests with respect to control zones, the building control and monitoring system 100 can improve resource billing accuracy. Using the features described above, the billing module 210 can more accurately calculate the actual use of each occupant and bill occupants accordingly. By directly reflecting use by each occupant in their bill, the building control and monitoring system 100 can also encourage energy savings and more environmentally-conscious behaviors for their occupants.

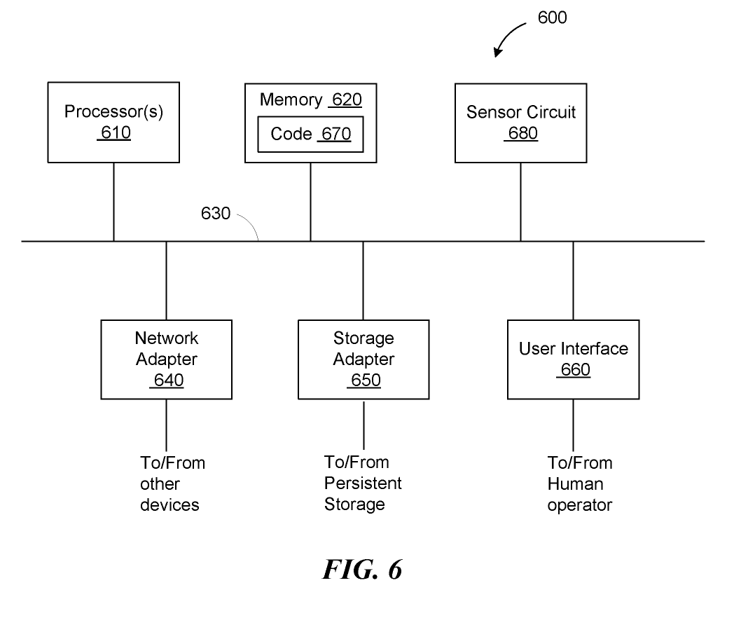

FIG. 6 is a block diagram of an example computing device 600 in accordance with various embodiments. The computing device 600 can include one or more computing devices (e.g., devices illustrated in FIG. 1, such as the system managing devices 112, the building subsystems or components thereof, the linking devices 136, the communication nodes 138, the sensors 140, including the presence sensors 142, the user devices 152, etc.) that implement at least a portion of the process 500 of FIG. 5. The computing device 600 includes one or more processors 610 and memory 620 connected to an interconnect 630. The interconnect 630 is an abstraction that represents any one or more separate physical buses, point-to-point connections, or both connected by appropriate bridges, adapters, or controllers. The interconnect 630, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”. The interconnect 630 can also include wireless connection or communications between components.

The processor(s) 610 is/are the central processing unit (CPU) of the computing device 600 and thus controls the overall operation of the computing device 600. In certain embodiments, the processor(s) 610 accomplishes this by executing software or firmware stored in memory 620. The processor(s) 610 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 620 is or includes the main memory of the computing device 600. The memory 620 represents any form of random access memory (RAM), read-only memory (ROM), flash memory, or the like, or a combination of such devices. In use, the memory 620 may contain a code 670 (e.g., applications, device-specific executables, etc.) containing instructions according to the operation of at least a portion of the process 500 disclosed herein. The code 670 stored in memory 620 may be implemented as software and/or firmware to program the processor(s) 610 to carry out actions described above. In certain embodiments, such software or firmware may be initially provided to the computing device 600 by downloading it from a remote system through the computing device 600 (e.g., via network adapter 640).

Also connected to the processor(s) 610 through the interconnect 630 may be a network adapter 640 and/or a storage adapter 650. The network adapter 640 provides the computing device 600 with the ability to communicate with remote devices, over a network and may be, for example, an Ethernet adapter, Fibre Channel adapter, or a wireless modem. The network adapter 640 may also provide one or more devices in the building 104 of FIG. 1 with the ability to communicate with other computers. The storage adapter 650 enables the computing device 600 to access a persistent storage, and may be, for example, a Fibre Channel adapter or SCSI adapter.

The computing device 600 can further include one or more user interfaces 660 connected to the interconnect 630. The user interfaces 660 can communicate information to a user and/or receive inputs/information from the user. For example, the user interfaces 660 can include a display screen, a speaker, a haptic device, etc. Also, the user interfaces 660 can include a touch screen, a keyboard, a mouse, a microphone, etc. Also, the user interfaces 660 can include one or more GUIs.

In some embodiments, the computing device 600 can include a sensor circuit 680 connected to the interconnect 630. The sensor circuit 680 can measure one or more aspects of the surrounding environment. For example, the sensor circuit 680 can include various sensors discussed above, such as one or more circuits configured to measure/detect thermal energy/temperature, waves (e.g., light, sound, etc.), particles and/or gases, acceleration, magnetic field, device orientation, or a combination thereof.

Overall, the system/process described herein may be implemented for execution by any suitable computing environment in which the invention can be implemented. The system may be implemented by routines executed by a general-purpose data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a network. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

It is understood that the above described embodiments can be implemented using one or more devices (e.g., processors, Field Programmable Gate Arrays (FPGAs), state machines, memory devices, such as volatile or non-volatile memory, communication devices, such as modems or transceivers, user or device interfaces, or a combination thereof). Further, the discussed embodiments can be implemented in a networked environment. For example, the system can interact with the consumer through a user device (e.g., a personal computer or a laptop computer, a mobile device, etc.), which can be connected to one or more service provider devices (e.g., servers) implementing or executing one or more processes discussed above. The service provider devices can include lender devices or be separately connected to the lender devices (e.g., servers belonging to or operated by the lenders). The various devices can be connected using a communication network (e.g., telephone network, a local area network (LAN), a wide area network (WAN), a cellular network, etc.).

### CONCLUSION

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the disclosed technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

These and other changes can be made to the disclosed technology in light of the above Detailed Description. While the Detailed Description describes certain examples of the disclosed technology as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A method of operating a system that controls at least one environmental condition in a building, the method comprising:
receiving an environment setting request from a user device;
determining a current location representing a location of the user device, wherein the current location is within the building;
identifying a control zone in the building that includes the current location;
determining at least one system setting that corresponds to the environment setting request, wherein operating the system at the system setting adjusts the environmental condition at the control zone; and
communicating the system setting to the system to control the environmental condition based on the environment setting request.

2. The method of claim 1, wherein:
the environment setting request includes a temperature setting request; and
the system includes a heating-ventilation and air-conditioning (HVAC) system.

3. The method of claim 2, wherein the setting includes a fan speed, a thermostat setting, or a combination thereof for controlling a fan, a vent, a heating mechanism, a cooling mechanism, or a combination thereof of the HVAC system.

4. The method of claim 1, wherein the control zone is within an open area that includes multiple occupant spaces.

5. The method of claim 1, wherein the control zone includes multiple occupant spaces.

6. The method of claim 1, further comprising:
recording sensor readings from at least one sensor located at a known location inside or within a threshold distance from the control zone; and
autonomously adjusting boundaries of the control zone according to the sensor readings detected after the system setting is communicated to the system.

7. The method of claim 6, further comprising generating a prediction model that estimates a change in the environmental condition over time at the control zone according to at least an initial setting, a degree of change in setting, a targeted condition, a number of occupants in the control zone, locations of the occupants in the control zone, or a combination thereof.

8. The method of claim 1, further comprising:
tracking a user location history based on continuously storing the current location with a time stamp;
calculating at least one path-calculation component in the building based at least in part on the user location history, wherein the path-calculation component includes an edge, a node, an occupant space, or a combination thereof; and
estimating at least one structure location based on the path-calculation component, wherein the one structure location represents a structure integral with or attached to the building.

9. The method of claim 8, further comprising generating a prediction model based on the estimated structure location, wherein the prediction model estimates a change in the environmental condition over time at the control zone according to the structure location.

10. The method of claim 8, further comprising autonomously adjusting boundaries of the control zone according to the estimated structure location.

11. The method of claim 1, further comprising:
identifying an occupant having an assigned space in the control zone; and
determining an access set associated with the occupant, the access set representing an authorization enabling control of the environmental conditions at the control zone, and wherein determining the system setting includes determining the system setting according to the environment setting request and the access set when the environment setting request is from the user device unassociated with the occupant.

12. The method of claim 11, wherein determining the system setting includes calculating a weighted average between a setting designated by the occupant and the environment setting request, wherein the weighted average is calculated using weights that are associated with the access set.

13. The method of claim 1, further comprising:
determining a location history based on tracking the current location over time;
calculating a stay duration based on the location history; and
calculating a cost based on the stay duration and the location history.

14. The method of claim 13, wherein calculating the cost includes calculating the cost based on calculating a portion of a total expenditure that corresponds to the stay duration, wherein the total expenditure represents a cost associated with maintaining the environmental conditions at the control zone.

15. The method of claim 13, wherein calculating the cost includes calculating the cost according to the environment setting request.

16. A system for controlling at least one environmental control system of a building, the system comprising:
at least one computer-based processor; and
at least one computer-based memory connected to the computer-based processor and having stored thereon instructions executable by the computer-based processor to cause the computer-based processor to:
receive an environment setting request from a user device;
determine a current location representing a location of the user device, wherein the current location is within the building;
identify a control zone in the building that includes the current location;
determine at least one system setting that corresponds to the environment setting request, wherein operating the environmental control system at the system setting adjusts the environmental condition at the control zone; and
communicate the system setting to the environmental control system to control the environmental condition based on the environment setting request.

17. The system of claim 16, further comprising a surface-mount device connected to the computer-based processor, the surface-mount device comprising:
a power system;
a central communication circuit connected to the power system and configured to communicate information with the computer-based processor; and
an operational circuit connected to the central communication circuit and configured to provide interrupt signals used to control operating modes of one or more circuits within the surface-mount device, wherein the surface-mount device is configured to attach to a surface of a structure of the building.

18. The system of claim 17, wherein:
the computer-based processor comprises a system managing device; and
the surface-mount device includes a second communication circuit connected to the central communication circuit and the environmental control system, the second communication circuit configured to provide an interface between the system managing device and the environmental control system that was initially disconnected from the system managing device.

19. The system of claim 17, wherein the surface-mount device includes a second communication circuit connected to the central communication circuit, wherein the second communication circuit is configured to communicate with one or more user devices located within the building.

20. A tangible, non-transient computer-readable medium having processor instructions encoded thereon that, when executed by one or more processors, configures the one or more processors to perform a method of controlling at least one environmental condition in a building, the instructions comprising:
receiving an environment setting request from a user device;
determining a current location representing a location of the user device, wherein the current location is within the building;
identifying a control zone in the building that includes the current location;
determining at least one system setting that corresponds to the environment setting request, wherein operating the system at the system setting adjusts the environmental condition at the control zone; and
communicating the system setting to the system to control the environmental condition based on the environment setting request.
